(19) United States
(12) Patent Application Publication
(10) Pub. No.: US 2017/0251659 A1
(43) Pub. Date: Sep. 7, 2017

(54) Audible Wildlife Avoidance Unit

(71) Applicant: William R. Pereca, Highland Lakes, NJ (US)

(72) Inventor: William R. Pereca, Highland Lakes, NJ (US)

(21) Appl. No.: 15/448,959

(22) Filed: Mar. 3, 2017

Related U.S. Application Data
(60) Provisional application No. 62/389,627, filed on Mar. 4, 2016.

(51) Int. Cl. A01M 29/16; B60Q 5/00

(52) U.S. Cl. CPC A01M 29/16; B60Q 5/005

(57) ABSTRACT

This invention is a new type of automotive deer whistle that produces an audible whistle. The sound that is produced can defiantly be heard by humans and wildlife. This deer whistle is made to be mounted on the front of any vehicle that exceeds the speeds 40 mph, so to prevent collisions with deer and other wildlife.

### BACKGROUND OF THE INVENTION

Prior patented deer whistles have all been ultra-sonic. Meaning they can Not be heard by humans. Thus raising the question, can deer actually hear the whistle. The common consensus or feedback of ultrasonic whistles for the last thirty years is, was that they did not work. This audible deer whistle eliminates that question, whether or not deer can really hear the whistle, because it is audible. There is no doubt deer can hear the whistle sound. And all the feedback the inventor has received, is that the audible whistle Does actually work on deer.

### BRIEF SUMMARY OF THE INVENTION

The inventor of this audible whistle had used ultra-sonic whistles for over thirty years to avoid wildlife collisions, typically using two whistles per vehicle, as is suggested. In those years of use, the inventor Never saw any positive wildlife reactions at all. Since using just one audible whistle per vehicle for only three years, the inventor as well as many motorists who have purchased an audible whistle, have had countless positive wildlife reactions. Most being that deer and other wildlife, when hearing the audible whistle, would freeze or stop moving. Other reactions where that deer, groundhogs or birds would flee and move away from the direction of the whistle sound. These reactions to any reasonable person, are positive and will in general help lower a motorist odds or chances of striking wildlife, that may result in death and or a serious vehicle accident.

### DETAILED DESCRIPTION OF INVENTION

The Audible Wildlife Avoidance Unit is an audible deer whistle which produces a whistle or sound that is audible and can be heard by both humans and deer. It will be referred to as the “unit” herein. The unit is designed to be mounted on the front of any vehicle, motorcycle, ATV, bicycle or airplane, using two way, adhesive tape or by gluing on the unit. Only one unit is needed per vehicle and it is to be mounted in a spot on the vehicle so it receives a clean and or unobstructed flow of air or wind as the vehicles drives. The unit must also be level and face or aim directly straight in front of the vehicle. The function of this unit is to alert deer and other wildlife of the vehicles approach. And freeze or in some cases, scare the animal away from the traveling path of said vehicle, as to avoid a car and animal collision. The design of this unit is one solid body consisting of two equally sized tubes that pass through the unit from the wider front of the unit, where air or wind enters, to the rear of the unit, where air escapes. Each of the two tubes contains three smaller ridges that constrict the air and produce the whistle, when enough air consistently goes through the unit. The unit starts whistling at near or between 35-40 mph. And will continue to whistle up to, and exceeding 100 Mph.

The whistle is produced within each pipe using the “Venturi” effect, which is basically the change in air pressure that results when airflows through a constricted section, or choke of a pipe. In this case there us a change in air pressure three times, with in the unit.

This unit is different than any other automotive deer whistle that has ever been produced, in that the whistle sound that is produced, is NOT ultra-sonic, and emits an audible whistle sound. This patent is being filed on the design of the unit as well as the unit producing an “Audible” sound to humans and wildlife. The sound of the whistle in KHz is believed to be between 2 and 20 KHz, which is also within hearing range of deer and humans, as well as most other wildlife.The unit has been manufactured, marketed and sold in the northeast by Deer Screamer, (a sole proprietor business) since 2013. In that period, approximately 4000 units have been purchased by motorists, mostly in the state of NJ. Most of the feedback and or reviews of motorist that have used the unit, is that deer and other wildlife tend to freeze and look at the passing vehicle, which should reduce the chances of a wildlife collision. The unit is manufactured by pouring a two part plastic mix into a one piece rubber mold.

### BRIEF DESCRIPTION OF DRAWINGS

FIG. 1: Top View of whistle. Dotted lines depict the two tubes within body of unit. The front of the unit being on the right, and the rear of the unit to the left.

FIG. 2: Bottom View of whistle. The front of the unit being on the right, and the rear of the unit to the left.

FIG. 3: Side View of whistle. Dotted lines depict one of two tubes within body of unit. Second tube is directly.behind first tube.

FIG. 4: Front View of whistle. Inner circle depicts tube which air flows through.

FIG. 5: Side and Front of whistle. The front of the unit is facing to the right. Use FIG. 5 as the Main Drawing.

FIG. 6: Rear View of whistle. Inner circle depicts tube which air flows through.

FIG. 7: Enlarged view of one of two cylindrical tubes within body of unit.

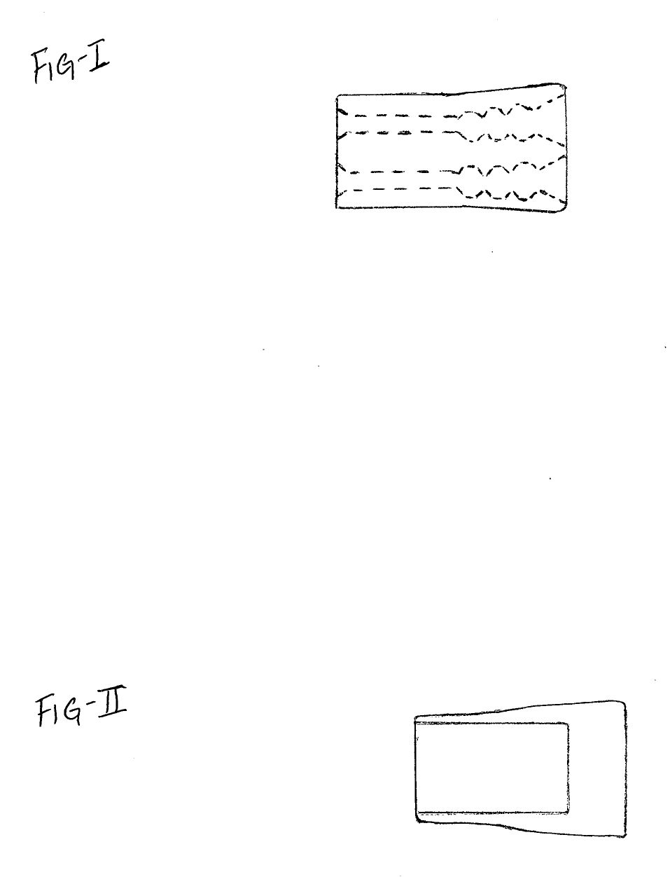

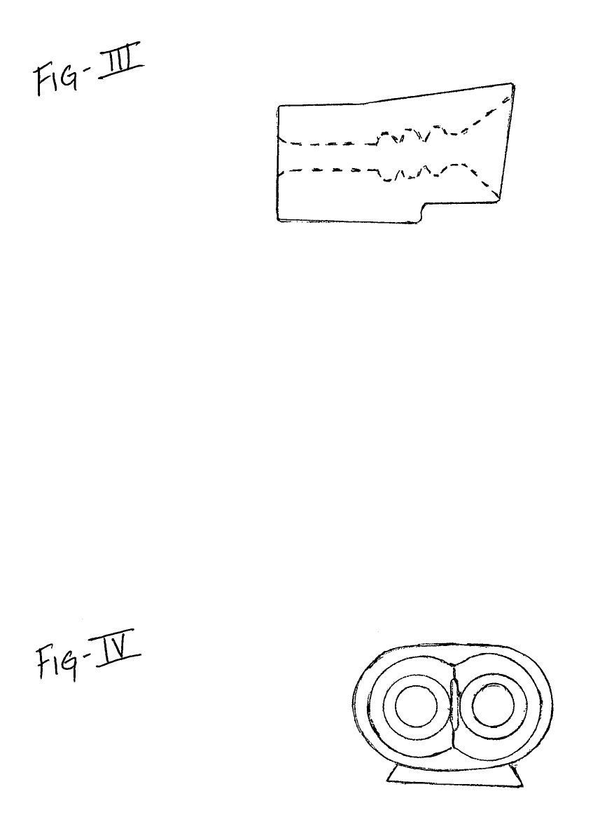

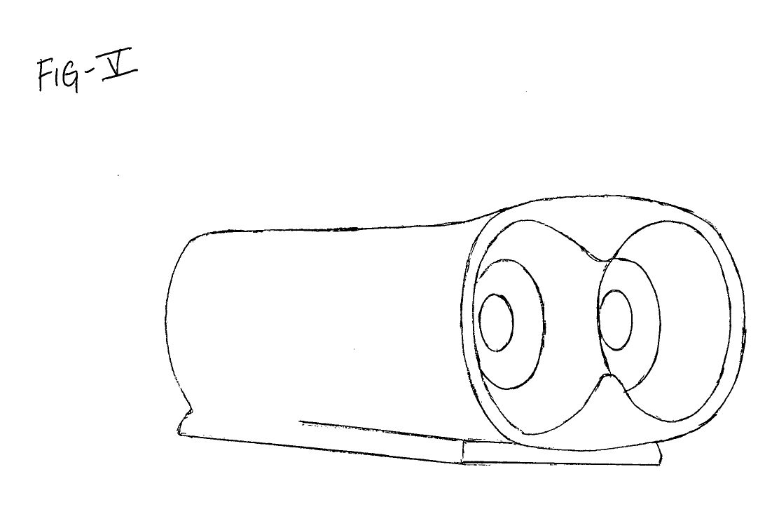

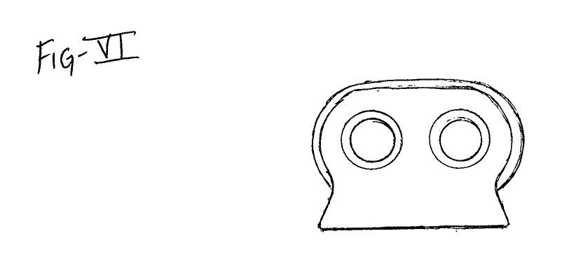

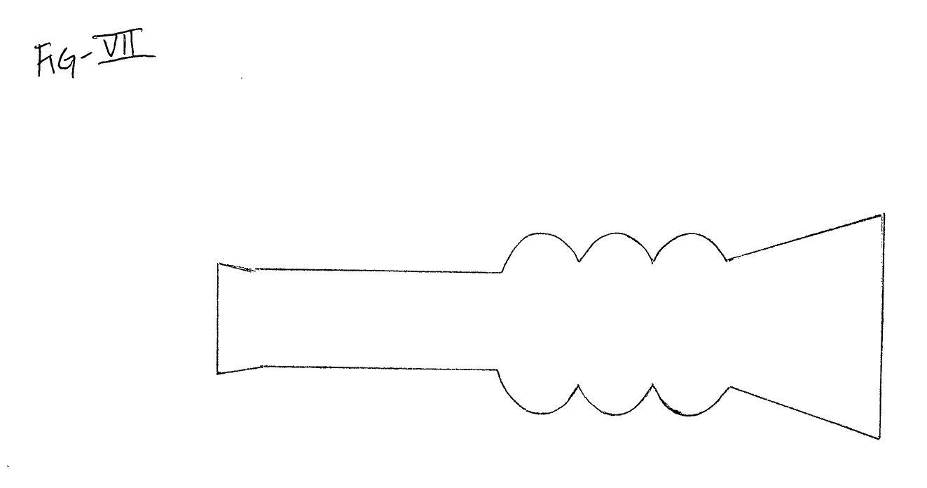

I) Using only one unit per vehicle, the unit produces a sound and or whistle that can defiantly be heard by deer, and that when most deer hear the whistle, they react by either freezing or running away from the direction in which the whistle is coming.

II) This audible whistle also claims to sometimes work on many other wildlife besides deer, including groundhogs, raccoon, fox, elk, black bear, antelope, wild turkey, and vultures.
